(19) United States
(12) Patent Application Publication
(10) Pub. No.: US 2026/0291239 A1
(43) Pub. Date: Sep. 24, 2026

(54) BLACKSTART CIRCUITS CONFIGURED FOR USE WITH POWER CONVERSION SYSTEMS

(71) Applicant: Enphase Energy, Inc., Fremont, CA (US)

(72) Inventors: Balakrishna G GUDI, Bangalore (IN); Pruthvi Chaithanya NAKKA, Bengaluru (IN); Satish Kumar SINGH, Jeevan Bhima Nagar (IN); Alluri BHARATH, Bangalore (IN)

(21) Appl. No.: 19/569,410

(22) Filed: Mar. 17, 2026

Related U.S. Application Data
(60) Provisional application No. 63/773,596, filed on Mar. 18, 2025.

(51) Int. Cl. H02J 3/32; H02J 3/38; H02J 3/388; H02J 7/00; H02J 7/35; H02J 101/24; H02M 1/44; H02M 7/797

(52) U.S. Cl. CPC H02J 3/32; H02J 3/381; H02J 3/388; H02J 7/35; H02J 7/855; H02M 1/44; H02M 7/797; H02J 2101/24; H02J 2207/20

(57) ABSTRACT

A blackstart circuit configured for use with an energy management system is provided and comprises a diode bridge rectifier (DBR) section configured to connect to a distributed energy resource (DER) of the energy management system for receiving a DER input voltage. A FET based start-up section can be connected to the DBR section and upon receiving the DER input voltage can be configured to transmit a blackstart command that ramps a first voltage at the FET based start-up section to a second voltage, different from the first voltage, that is provided to a flyback section configured to perform a blackstart operation for a power conditioning unit of the distributed energy resource (DER).

### CROSS-REFERENCE TO RELATED APPLICATIONS

The present application claims the benefit of and priority to U.S. Provisional Application Ser. No. 63/773,596, filed on Mar. 18, 2025, the entire contents of which is hereby incorporated by reference.

### BACKGROUND

### Field of the Disclosure

Embodiments of the present disclosure relate generally to distributed power generation systems and, more particularly, to blackstart circuits configured for use with power conversion systems.

### Description of the Related Art

In an Electric Power System (EPS), a blackstart (e.g., using a blackstart circuit) is the process of restoring power after an outage or start-up of a purely off-grid system with no connection to a power grid. In at least some instances, the blackstart circuit is configured so that multiple grid-forming inverters, which can be connected to a large load, can be powered up to start producing current simultaneously. While conventional blackstart circuits are suitable for their intended purpose, such blackstart circuits are, typically, expensive, are relatively large (e.g., space consuming on a printed circuit board assembly (PCBA)), have a relatively low efficiency, are complex to assemble, have reliability, electromagnetic interference (EMI), and electromagnetic interference compatibility (EMC) concerns, do not have controller area network (CAN) communication support, and have component availability issues (e.g., bulky capacitors can have supply chain issues with single vendors).

Therefore, there is a need for improved blackstart circuits configured for use with power conversion systems.

### SUMMARY

In at least some embodiments, a blackstart circuit comprises a blackstart circuit configured for use with an energy management system. The blackstart circuit can comprise a diode bridge rectifier (DBR) section configured to connect to a distributed energy resource (DER) of the energy management system for receiving a DER input voltage. A FET based start-up section can be connected to the DBR section and upon receiving the DER input voltage can be configured to transmit a blackstart command that ramps a first voltage at the FET based start-up section to a second voltage, different from the first voltage, that is provided to a flyback section configured to perform a blackstart operation for a power conditioning unit of the distributed energy resource (DER).

In at least some embodiments, an energy management system can comprise a distributed energy resource (DER), a power conditioning unit connected to the distributed energy resource (DER), and a blackstart circuit. The blackstart circuit can comprise a diode bridge rectifier (DBR) section configured to connect to a distributed energy resource (DER) of the energy management system for receiving a DER input voltage. A FET based start-up section can be connected to the DBR section and upon receiving the DER input voltage can be configured to transmit a blackstart command that ramps a first voltage at the FET based start-up section to a second voltage, different from the first voltage, that is provided to a flyback section configured to perform a blackstart operation for a power conditioning unit of the distributed energy resource (DER). These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of a system for power conversion, in accordance with one or more embodiments of the present disclosure;

FIG. 2 is a block diagram of a power conditioner controller, in accordance with one or more embodiments of the present disclosure;

FIG. 3 is a schematic diagram of a blackstart circuit configured for use with the system for power conversion, in accordance with one or more embodiments of the present disclosure;

FIG. 4 shows a top graph of a waveform during touch-safe operation of the blackstart circuit of FIG. 3, a middle graph of a waveform during blackstart operation of the blackstart circuit of FIG. 3, and a bottom graph of the waveform zoomed in at a time of the blackstart operation, in accordance with one or more embodiments of the present disclosure; and

FIG. 5 is a graph of waveforms during operation of the blackstart circuit of FIG. 3, in accordance with one or more embodiments of the present disclosure.

### DETAILED DESCRIPTION

Embodiments of the present disclosure generally relate to improved blackstart circuits configured for use with power conversion systems. For example, a blackstart circuit configured for use with an energy management system can comprise a diode bridge rectifier (DBR) section configured to connect to a distributed energy resource (DER) of the energy management system for receiving a DER input voltage. A FET based start-up section can be connected to the DBR section and upon receiving the DER input voltage can be configured to transmit a blackstart command that ramps a first voltage at the FET based start-up section to a second voltage, different from the first voltage, that is provided to a flyback section configured to perform a blackstart operation for a power conditioning unit of the distributed energy resource (DER). Compared to conventional blackstart circuits, the blackstart circuits described herein are not expensive, are not space consuming on a PCBA, have a relatively high efficiency, are relatively simple to assembly, do not have reliability, EMI, and EMC concerns, support CAN communication, and do not have component availability issues because low voltage electrolytic capacitors can be used instead of bulky capacitors.

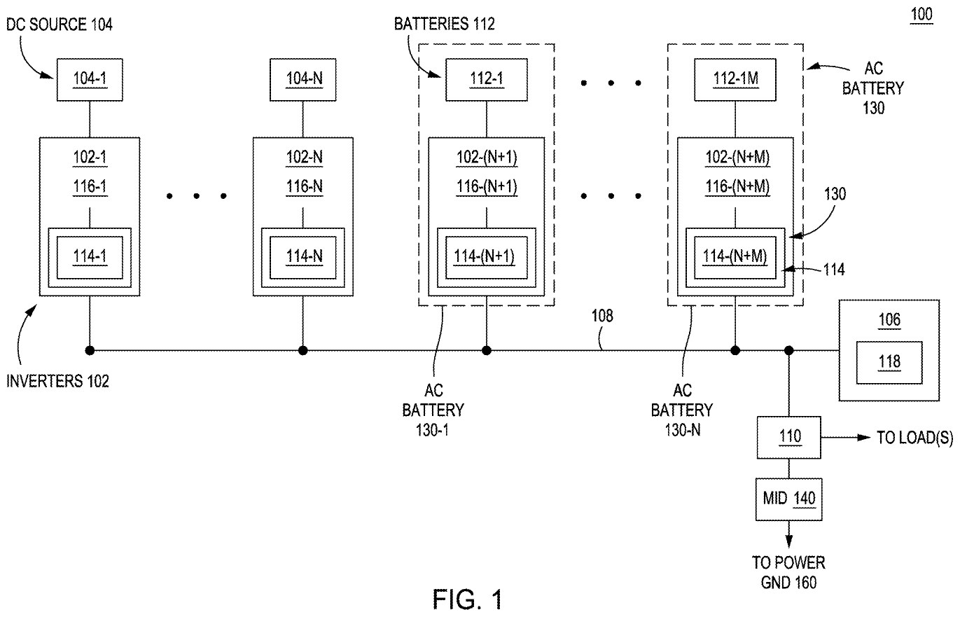

FIG. 1 is a block diagram of a system 100 (e.g., an energy management system) for power conversion using one or more embodiments of the present disclosure. This diagram only portrays one variation of the myriad of possible system configurations and devices that may utilize the present disclosure.

The system 100, which may also be referred to as a microgrid or a distributed resource island system (DRIS), is a distributed power generation system that comprises a plurality of power conditioners 102-1, . . . 102-N, . . . 102-N+M, collectively referred to as power conditioners 102 (e.g., a power conditioning unit) ; a plurality of DC power sources 104-1 . . . 104-N, collectively referred to as DC power sources 104; a plurality of energy storage/delivery devices (e.g., batteries) 112-1 . . .112-M, collectively referred to as energy storage/delivery devices 112; a system controller 106; an AC bus 108; and a load center 110. The DC power sources 104 (e.g., which can be considered a distributed energy resource) may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In some embodiments, such as the embodiments described with respect to FIG. 1, the DC power sources 104 are PV modules. Although the energy storage/delivery devices (e.g., which can also be considered a distributed energy resource) may be any suitable device that can store energy and deliver the stored energy for use (e.g., batteries, hydroelectric dams, or the like), in the embodiments described herein with respect to FIG. 1 the energy storage/delivery devices are batteries and are referred to herein as batteries 112.

The power conditioners 102 are bi-directional grid-forming DC: AC inverters, although in other embodiments the power conditioners 102 may be other types of power converters (e.g., AC-AC matrix converters). In addition to power conversion components, the power conditioners 102 comprise components known in the art (not shown in FIG. 1) to facilitate power conversion and/or the techniques described herein, such as current monitors and voltage monitors for monitoring DC current/voltage and AC current/voltage, transceivers for communicating with other power conditioners and/or the system controller 106 (e.g., via wired techniques such as power line communication (PLC), and/or wireless techniques), and the like.

Each power conditioner 102-1 . . . 102-N is coupled to a PV module 104-1 . . . 104-N, respectively, in a one-to-one correspondence, although in some other embodiments multiple DC power sources may be coupled to one or more of the power conditioners 102. Each power conditioner 102-(N+1) . . . 102-(N+M) is coupled to a battery 112-1 . . . 112-(M), respectively, in a one-to-one correspondence (although in other embodiments a single battery may be coupled to multiple power conditioners, where each pairing of a power conditioner 102 and a battery 112 forms an “AC battery” 130 (e.g., the corresponding batteries and the power conditioner 102-(N+1) form the AC battery 130-1, and the battery 112-M and the power conditioner 102-(N+M) form the AC battery 130-M). The power conditioners 102 are coupled to the system controller 106 via the AC bus 108. The AC bus 108 can be further coupled to one or more loads and a power grid 160 (e.g., a commercial grid, one or more other microgrids, or the like) via the load center 110.

The system controller 106 comprises a controller 118 and may communicate with the power conditioners 102 by wireless and/or wired communication (e.g., power line communication (PLC)) for providing operative control and/or monitoring of the power conditioners 102 (e.g., communicating commands to the power conditioners 102, obtaining data (for example regarding the performance of the power conditioners 102) from the power conditioners 102, and the like). Additionally, the power conditioners 102 may communicate with one another by wireless and/or wired communication (e.g., PLC). In some embodiments, the system controller 106 may be a gateway for receiving information from and/or sending information to another device (such as a remote master controller, not pictured) via a communications network, for example via the Internet. In such embodiments, the system controller 106 may communicate information pertaining to the power conditioners 102 (e.g., performance data) to the remote master controller, and/or communicate data received from the remote master controller (e.g., control commands) to one or more of the power conditioners 102.

The system 100 further comprises a MID 140 (microgrid interconnect device), which may also be referred to as an island interconnect device (IID), for determining when to disconnect from/connect to the power grid 160, and for performing the disconnection/connection. For example, the MID 140 may detect a grid fluctuation, disturbance or outage and, as a result, disconnect the system 100 from the power grid 160. Once disconnected from the power grid 160, the system 100 can continue to generate power as an intentional island without imposing safety risks on any line workers that may be working on the power grid 160. The MID 140 comprises a disconnect component (e.g., a contactor or the like) for physically disconnecting/connecting the system 100 to the grid or a larger microgrid. In some embodiments, the MID 140 may additionally comprise an autoformer for coupling the system 100 to a split-phase load that may have a misbalance in it with some neutral current. In other embodiments, when the system operates only as an island, the MID 140 may not be present.

In some alternative embodiments, the system controller 106 comprises the MID 140 or a portion of the MID 140. For example, the system controller 106 may comprise an islanding module for monitoring the power grid 160, detecting grid failures and disturbances, determining when to disconnect from/connect to the power grid 160, and driving a disconnect component accordingly, where the disconnect component may be part of the system controller 106 or, alternatively, separate from the system controller 106. In other embodiments, such as the embodiment depicted in FIG. 1, the MID 140 is separate from the system controller 106 and comprises a disconnect component as well as a CPU and an islanding module for monitoring the power grid 160, detecting grid failures and disturbances, determining when to disconnect from/connect to the power grid 160, and driving the disconnect component accordingly. In some embodiments, the MID 140 may coordinate with the system controller 106, e.g., using power line communications and/or wireless communication. Thus, the disconnection/connection of the system 100 to the power grid 160 is a controlled process driven by the MID 140.

The power conditioners 102-1 . . . 102-N convert the DC power from the DC power sources 104 to AC output power and couple the generated output power to the load center 110 via the AC bus 108. The load center 110 is further coupled to the power grid 160 (e.g., the commercial power grid, a larger microgrid, or the like) as well as to one or more loads (e.g., electrical appliances). The power conditioners 102-(N+1) . . . 102-(N+M) are bidirectional converters that can convert AC from the AC bus 108 to DC and store the resulting energy in the corresponding batteries 112-1...112-M, and can convert DC from the corresponding batteries 112-1 . . . 112-M to AC that is then coupled to the AC bus 108. As such, the system 100 can generate AC output power during daylight hours via the DC power sources 104, store at least a portion of the generated energy in the batteries 112, and continue to generate AC output during the evening hours using the energy stored in the batteries 112. While connected to the power grid 160, the power conditioners 102 may operate in a “power mode” where the grid voltage is used as a reference voltage for synchronizing the output from the power conditioners 102.

In accordance with one or more embodiments of the present disclosure, each of the power conditioners 102-1 . . . 102-(N+M) comprises a corresponding controller 116-1 . . . 116-(N+M) having a blackstart module 114-1 . . . 114(N+M) for providing a decentralized blackstart that addresses synchronization of timing and current direction for the power conditioners 102 when the system 100 is islanded and de-energized. The system 100 may be islanded (i.e., not connected to the power grid 160) for a variety of reasons; for example, the MID 140 may disconnect the system 100 from the power grid 160 following a power failure on the power grid 160, a user may manually disconnect the system 100 from the power grid 160 to perform maintenance and/or add components, the system 100 may have been installed and not yet connected to the power grid 160, the system 100 may be configured for no connection to the power grid 160 (i.e., as a purely off-grid system), or the like. In some embodiments, the system 100 may be de-energized when islanded as a result of its load exceeding the system generation capability. In other embodiments, the system 100 may be de-energized when islanded as a result of receiving insufficient input from the DC power sources 104 and 112. For example, in one or more embodiments where the DC power sources 104 are PV modules, the system 100 may become de-energized while islanded during the night when the PV modules are not producing any output and if the batteries 112 have insufficient storage to meet load demand. In still other embodiments, the system 100 may be intentionally de-energized while islanded to conduct routine maintenance or to expand the system 100. Prior to the blackstart, one or more loads (such as non-critical loads) may be disconnected from the system 100 as necessary.

While the system 100 is islanded, those power conditioners 102 having sufficient DC input begin initiating a blackstart to transition from de-energized to an active grid, either at a soft-grid level or at nominal voltage. When the load is sufficiently large to require multiple power conditioners 102 to activate at the same time, the power conditioners 102 will be synchronized to activate simultaneously as described herein.

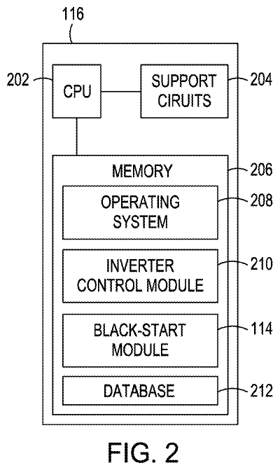

FIG. 2 is a block diagram of a power controller 116 in accordance with one or more embodiments of the present disclosure. The power controller 116 comprises support circuits 204 and a memory 206 (e.g., a non-transitory computer readable storage medium), each coupled to a CPU 202 (central processing unit). The CPU 202 may comprise one or more conventionally available microprocessors or microcontrollers; alternatively, the CPU 202 may include one or more application specific integrated circuits (ASICs). The support circuits 204 are well known circuits used to promote functionality of the CPU 202. Such circuits include, but are not limited to, a cache, power supplies, clock circuits, buses, input/output (I/O) circuits, and the like. The power controller 116 may be implemented using a general purpose computer that, when executing particular software and/or firmware, becomes a specific purpose computer for performing various embodiments of the present disclosure. In other embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these and/or other types of memory. The memory 206 is sometimes referred to as main memory and may, in part, be used as cache memory or buffer memory. The memory 206 generally stores the OS 208 (operating system), if necessary, of the power controller 116 that can be supported by the CPU capabilities. In some embodiments, the OS 208 may be one of a number of commercially available operating systems such as, but not limited to, LINUX, Real-Time Operating System (RTOS), and the like.

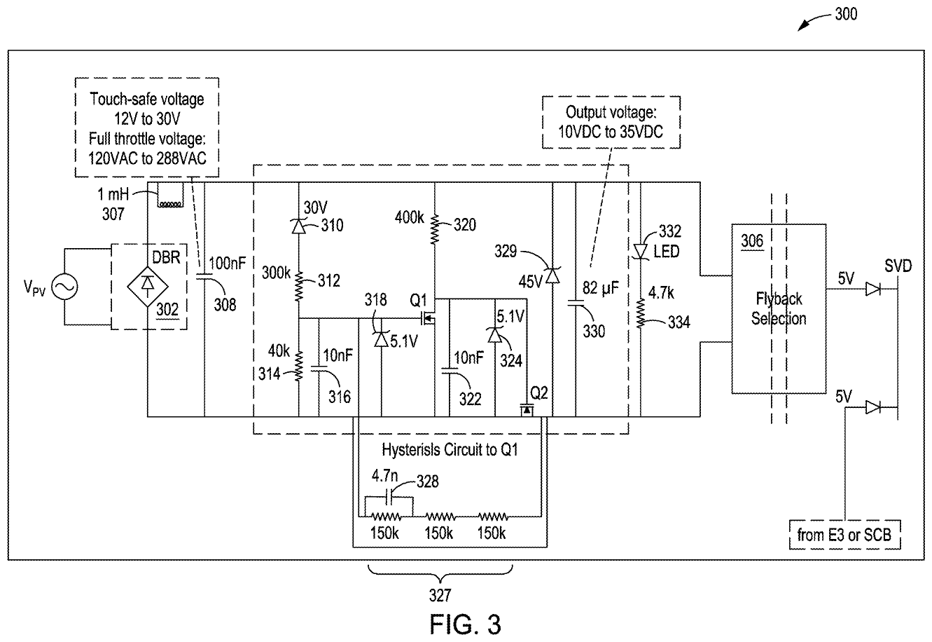

The memory 206 stores various forms of application software and/or firmware, such as a power conditioner control module 210 for controlling operation of the power conditioner 102 (e.g., DC-AC conversion, AC-DC conversion, communication, and the like) and a blackstart module 114 for controlling, when executed, the power conditioner blackstart functionality as described herein. Further detail on the functionality provided by the blackstart module 114 is described below with respect to FIG. 3.

The memory 206 may additionally store a database 212 for storing data related to the operation of the power conditioner 102 and/or the present disclosure.

In various embodiments, one or more power conditioner units (e.g., PCUs) can be configured to attempt a blackstart. For example, as noted above, improved blackstart circuits configured for use with power conversion systems are described herein. For example, FIG. 3 is a schematic diagram of a blackstart circuit 300 (PCBA) configured for use with the system for power conversion, in accordance with one or more embodiments of the present disclosure. For example, the blackstart circuit 300 comprises three main sections comprising a DBR section 302 (diode bridge rectifier), a FET based start-up section 304, and a flyback section 306.

The DBR section 302 can connect to a DER connector for receiving a DER input voltage (e.g., from a power supply board of a DER (PV)). The DBR section 302 can comprise one or more capacitors, diodes, FETS, fuses, inductors, and/or resistors, etc. (not shown) connected in parallel/series that form the DBR circuitry that is used for a blackstart process. In at least some embodiments, one or more capacitors (e.g., a capacitor 308) that are configured to store a voltage ranging from about 12 V to about 360 V can be coupled across the DBR section 302. For example, in at least some embodiments, the capacitor 308 can be configured to store a voltage from about 12 VDC to about 30 VDC, which can be considered a touch-safe voltage. Additionally, the capacitor 308 can be configured to store a voltage from about 120 VAC to about 360 VAC, which can be considered a full throttle voltage. In at least some embodiments, the full throttle voltage can be about 288 V. An inductor 307 can be connected between the DBR section 302 and the capacitor 308 and, in conjunction with the capacitor 308, can provide surge protection during operation.

In at least some embodiments, a CLC filter (a capacitor filter followed by an LC filter, not shown) can be provided in the DBR section 302 (or as a separate section) and can comprise one or more capacitors, diodes, FETS, fuses, inductors, and/or resistors, etc. The CLC filter can be configured for a resonating frequency of about 33.25 kHz, which allows the blackstart circuit 300 to operate, and a cut-off frequency of about 52.78 kHz, which does not allow the blackstart circuit 300 to operate. In at least some embodiments, a cutoff frequency can be about ⅕ to 1/10 times of a flyback IC switching frequency, e.g., to address EMI/EMC issues.

The FET based start-up section 304 comprises one or more capacitors, diodes, FETS, fuses, inductors, and/or resistors, etc. For example, the FET based start-up section 304 can comprise one or more diodes 310 connected in parallel/series to each other and one or more resistors 312, which can also be connected in parallel/series to each other. For example, the one or more diodes 310 can be rated with a voltage of about 10 V to 40 V, e.g., based on the voltage to be regulated at one or more capacitors 330. In at least some embodiments, the one or more diodes 310 can be rated with a voltage of about 30 V, and the one or more resistors 312 can have a resistance of about 300 kΩ. Additionally, one or more capacitors, diodes, FETS, fuses, inductors, and/or resistors, etc. can be connected in parallel/series to the one or more diodes 310 and the one or more resistors 312 and to each other. For example, one or more resistors can be connected in parallel/series to each other, one or more capacitors can be connected in parallel/serial to each other, and one or more diodes, can be connected in parallel/series to each other. In at least some embodiments, one or more resistors 314, one or more capacitors 316, and one or more diodes 318 can be coupled in parallel to each other. In at least some embodiments, the one or more resistors 314 can have a resistance of about 40 kΩ to about 150 kΩ, the one or more capacitors 316 can have a capacitance of about 10 nF to about 100 nF, and one or more diodes 318 can be rated with a voltage of about 4.5V to 10V, e.g., based on FET Q1 Vgs specifications. In at least some embodiments, the one or more diodes 318 can be rated with a voltage of about 5.1 V. In at least some embodiments, the one or more resistors 314, one or more capacitors 316, and one or more diodes 318 can be coupled across a gate of a FET Q₁ (e.g., a MOSFET). During operation, the FET Q₁ can turn on when a predetermined voltage is applied to the FET Q₁. In at least some embodiments, the FET Q₁ can turn on for voltages above 38 VDC. Additionally, one or more resistors 320 can be connected in series to each other and to a drain of the FET Q₁. In at least some embodiments, the one or more resistors 320 can have a resistance of about 400 kΩ. In at least some embodiments, the one or more resistors 320 can have a resistance in steps of 100 k, 200 k, etc. up to 800 k, e.g., based on the desired turn on delay for the FET Q2. Moreover, one or more capacitors 322 and one or more diodes 324 can be connected in parallel/series to each other and to the one or more resistors 320 and connected to the drain of the FET Q₁. The one or more capacitors 322 can have a capacitance of about 10 nF to about 100 nF and one or more diodes 324 can be rated with a voltage of about 4.5V to 10V, e.g., based on Q2 FET Vgs specifications. In at least some embodiments, the one or more diodes 324 can be rated with a voltage of about 5.1 V. In at least some embodiments, one or more resistors (not shown) can be connected in parallel to the one or more capacitors 322 and one or more diodes 324. In at least some embodiments, a voltage at the one or more diodes 324 can be applied to a gate of the FET Q₂ (MOSFET), which is configured to connect or disconnect the DBR section 302 ground to the flyback section 306 ground. During operation, the FET Q₂ can turn on when a predetermined voltage is applied to the FET Q₂. In at least some embodiments, the FET Q₂ can turn on for voltages from about 5 VDC to about 8 VDC. In at least some embodiments, an additional FET (MOSFET, not shown) can be connected in series with the FET Q₂, e.g., to avoid single point failure of the FET Q2 shorting drain to source.

A hysteresis circuit 326 can be connected to the FET Q₁. For example, the hysteresis circuit 326 can be connected parallel to the FET Q₁ and can comprise one or more resistors, capacitors, inductors, etc. In at least some embodiments, the hysteresis circuit 326 can comprise one or more resistors 327 and one or more capacitors 328, which can be connected in parallel to each other and to the one or more resistors 327. In at least some embodiments, the one or more capacitors 328 can be connected in parallel to one of the one or more resistors 327. In at least some embodiments, the one or more resistors 327 can have a resistance of about 400 kΩ to 1 MΩ (e.g., 450 kΩ) and the one or more capacitors 328 can have a capacitance of about 1 nF to 10 nF (e.g., 4.7 nF). The hysteresis circuit 326 can be configured to provide a positive feedback loop to reduce noise and stabilize switching behavior of the FET Q₁.

In at least some embodiments, the DBR section 302 and a portion of the FET based start-up section 304 (e.g., at/up to the FET Q₁) make up a high voltage circuit with a range of about 0 V to about 410 V. For example, during operation the high voltage circuit can provide a voltage at the capacitor 308 from about 12 VDC to about 30 VDC, which can be considered a touch-safe voltage, and a voltage from about 120 VAC to about 360 VAC, which can be considered a full throttle voltage.

The FET based start-up section 304 can further comprise one or more diodes and one or more capacitors that can be connected in parallel/series to the one or more resistors 320 and to each other. In at least some embodiments, one or more diodes 329 can be connected in parallel to one or more capacitors 330, which can be connected in parallel to each other. In at least some embodiments, the one or more capacitors 330 are configured to store a voltage ranging from about 10 VDC to about 38 VDC. In at least some embodiments, the one or more diodes 329 can be rated with a voltage of about 39 V to about 45 V, and the one or more capacitors 330 can have a capacitance of about 50 μF to 150 μF. In at least some embodiments, the one or more capacitors 330 can have a capacitance of about 82 nF. In at least some embodiments, the one or more capacitors 330 can be electrolytic capacitors.

One or more decoupling capacitors, diodes, resistors, and/or LEDs can be connected to the FET based start-up section 304. For example, in at least some embodiments, one or more capacitors (not shown) can be connected in parallel to each other and in parallel to an LED 332. In at least some embodiments, the one or more capacitors can have a capacitance of about 1 μF to about 100 nF. One or more diodes (not shown) can be connected in parallel to the one or more capacitors. The one or more diodes can be rated with a voltage of about 10 VDC to 35 VDC. In at least some embodiments, the one or more diodes can be rated with a voltage of about 28 VDC. Additionally, one or more resistors 334 can be connected in parallel/series (shown in series) to the LED 332. In at least some embodiments, the one or more resistors 334 can have an impedance of about 4.7 kΩ, e.g., based on the LED 332 drop and the one or more resistors 334. The LED 332 is configured to provide a visual indication that indicates that the startup section (e.g., blackstart operation) is active.

In at least some embodiments, a portion of the FET based start-up section 304 (e.g., at/from the FET Q₁) make up a low voltage circuit with a range of about 0 V to about 30 V. For example, during operation, the low voltage circuit can provide a voltage at the one or more capacitors 330 from about 10 VDC to about 35 VDC. The voltage at the one or more capacitors 330 can be applied to the flyback section 306.

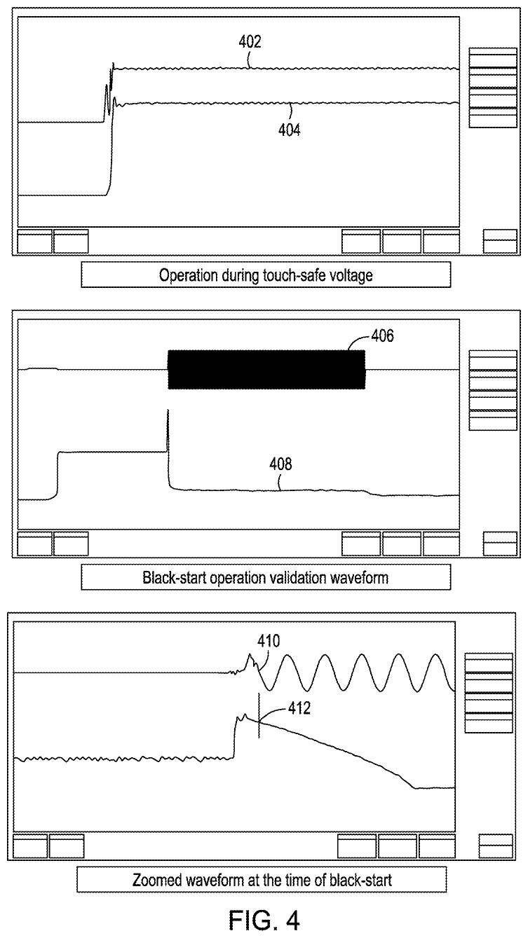

FIG. 4 shows a top graph of a waveform during touch-safe operation of the blackstart circuit of FIG. 3, a middle graph of a waveform during blackstart operation of the blackstart circuit of FIG. 3, and a bottom graph of the waveform zoomed in at a time of the blackstart operation, in accordance with one or more embodiments of the present disclosure. For example, as illustrated in the top graph, during operation (e.g., touch-safe voltage), the blackstart circuit 300 is configured to hold in-rush currents within limits, i.e., the FET Q₁ and the FET Q₂ are operating within safe operating area (SOA)—to operate without self-damage. For example, the capacitor 308 has a voltage of about 23 V (see 402) and the one or more capacitors 330 have a voltage of about 20 V (see 404). Next, as illustrated in the middle graph and bottom graph, during black start operation, the blackstart circuit 300 is configured to provide enough voltage at the one or more capacitors 330 (e.g., about 35 VDC, see 408), and, thus, to the flyback section 306, to blackstart one or more power conditioner units (e.g., eight PCUs). During the blackstart, the voltage at the capacitor 308 is about 360 VAC, see 406. As illustrated in the bottom graph, at the time of blackstart, the voltage at the one or more capacitors 330 can be about 41 VDC to about 5.6 VDC (see 412), and the voltage at the capacitor 308 can be about 370 VAC to about 390 VAC (see 410). The inventors have found that the overall PCBA efficiency of the blackstart circuit 300 can be about 66.54% at 20 VDC.

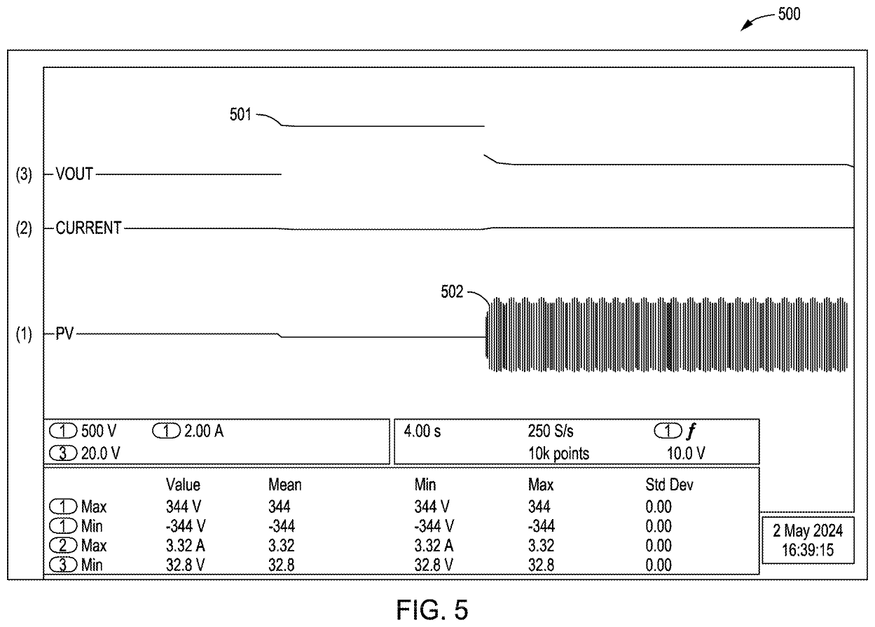

FIG. 5 is a graph 500 of waveforms during operation of the blackstart circuit of FIG. 3, in accordance with one or more embodiments of the present disclosure. For illustrative purposes, operation of the blackstart circuit 300 (PCBA) is described in terms of use with a single power supply, two microinverters, and one PLC_power conversion system (PCS) board. During operation of the blackstart circuit 300 (e.g., the blackstart module 114), a voltage VDC can be supplied/provided to the microinverters DC side. For example, a 40 VDC input can be supplied/provided by the V_{PV} (e.g., DC power sources 104) to the microinverters DC side. In doing so, the microinverter produces about 20 VDC (see 501, e.g., a touch-safe voltage). The 20 VDC turns on the start-up board circuit (e.g., the LED 332 (board LED) will illuminate). The start-up board sends out a blackstart command, and the microinverter starts ramping the voltage from the touch-safe voltage to about 240 VAC (see 406 and 502, e.g., 344 Vpp). As the Bridge o/p voltage hits about 35 VDC, the FET circuit (e.g., the FET Q₁) opens up and the PLC_PCS Board turns off. Once the PLC messages stop upon blackstart, the microinverters sustain the 240 VAC for a predetermined time (e.g., about 18 sec) and then falls to zero.

While the foregoing is directed to embodiments of the present disclosure, other and further embodiments of the disclosure may be devised without departing from the basic scope thereof, and the scope thereof is determined by the claims that follow.

1. A blackstart circuit configured for use with an energy management system, comprising:
a diode bridge rectifier (DBR) section configured to connect to a distributed energy resource (DER) of the energy management system for receiving a DER input voltage; and
a FET based start-up section connected to the DBR section and upon receiving the DER input voltage configured to transmit a blackstart command that ramps a first voltage at the FET based start-up section to a second voltage, different from the first voltage, that is provided to a flyback section configured to perform a blackstart operation for a power conditioning unit of the distributed energy resource (DER).

2. The blackstart circuit of claim 1, wherein the distributed energy resource (DER) is a photovoltaic (PV) module.

3. The blackstart circuit of claim 1, wherein the flyback section configured to perform the blackstart operation for a predetermined time of about 18 seconds.

4. The blackstart circuit of claim 1, wherein the first voltage is about 12 VDC to about 30 VDC.

5. The blackstart circuit of claim 1, wherein the second voltage is about 120 VAC to about 360 VAC.

6. The blackstart circuit of claim 1, further comprising an inductor connected between the DBR section and a capacitor of the FET based start-up section, wherein the inductor and the capacitor are configured to provide surge protection during operation.

7. The blackstart circuit of claim 1, wherein the DBR section comprises a CLC filter configured for a resonating frequency which allows the blackstart circuit to operate, and a cut-off frequency, which does not allow the blackstart circuit to operate.

8. The blackstart circuit of claim 7, wherein the resonating frequency and the cut-off frequency is 33.25 kHz and 52.78 kHz, respectively.

9. The blackstart circuit of claim 7, wherein the cut-off frequency is about ⅕ to 1/10 times of a flyback IC switching frequency.

10. The blackstart circuit of claim 1, further comprising a hysteresis circuit connected parallel to a FET of the FET based start-up section and configured to provide a positive feedback loop to reduce noise and stabilize switching behavior of the FET.

11. The blackstart circuit of claim 1, further comprising an LED configured to provide a visual indication that indicates that the blackstart operation is active.

12. An energy management system, comprising:
a distributed energy resource (DER);
a power conditioning unit connected to the distributed energy resource (DER); and
blackstart circuit configured comprising:
a diode bridge rectifier (DBR) section connected to the distributed energy resource (DER) for receiving a DER input voltage; and
a FET based start-up section connected to the DBR section and upon receiving the DER input voltage configured to transmit a blackstart command that ramps a first voltage at the FET based start-up section to a second voltage, different from the first voltage, that is provided to a flyback section configured to perform a blackstart operation for the power conditioning unit.

13. The energy management system of claim 12, wherein the distributed energy resource (DER) is a photovoltaic (PV) module.

14. The energy management system of claim 12, wherein the flyback section configured to perform the blackstart operation for a predetermined time of about 18 seconds.

15. The energy management system of claim 12, wherein the first voltage is about 12 VDC to about 30 VDC.

16. The energy management system of claim 12, wherein the second voltage is about 120 VAC to about 360 VAC.

17. The energy management system of claim 12, further comprising an inductor connected between the DBR section and a capacitor of the FET based start-up section, wherein the inductor and the capacitor are configured to provide surge protection during operation.

18. The energy management system of claim 12, wherein the DBR section comprises a CLC filter configured for a resonating frequency which allows the blackstart circuit to operate, and a cut-off frequency, which does not allow the blackstart circuit to operate.

19. The energy management system of claim 18, wherein the resonating frequency and the cut-off frequency is 33.25 kHz and 52.78 kHz, respectively.

20. The energy management system of claim 18, wherein the cut-off frequency is about ⅕0 to 1/10 times of a flyback IC switching frequency.
